(19) United States
(12) Patent Application Publication
(10) Pub. No.: US 2026/0274667 A1
(43) Pub. Date: Sep. 17, 2026

(54) METHOD FOR PRODUCING LITHIUM SULFIDE IN A CIRCULATING BED REACTOR

(71) Applicant: EURECAT S.A, La Voulte-sur-Rhône (FR)

(72) Inventors: Giuseppe Italiano, Valence (FR); Pauline Galliou, Saint-Laurent-du-Pape (FR); Philippe Kerleau, Valence (FR)

(21) Appl. No.: 19/140,460

(22) PCT Filed: Dec. 5, 2023
(86) PCT No.: PCT/FR2023/051927

§ 371 Date: Jun. 18, 2025

(30) Foreign Application Priority Data
Dec. 20, 2022 (FR) FR2213974

(51) Int. Cl. C01B 17/22; B01J 19/18; B01J 19/28

(52) U.S. Cl. CPC C01B 17/22; B01J 19/1818; B01J 19/1825; B01J 19/1831; B01J 19/285

(57) ABSTRACT

The present invention relates to a method for preparing lithium sulfide (Li₂S) from lithium hydroxide (LiOH) and hydrogen sulfide (H₂S), characterised in that the lithium hydroxide is sulfided in a reaction zone (9) comprising at least one moving bed tubular reactor (9a) having the configuration of an ascending vibrating spiral in which the lithium hydroxide (4) flows in countercurrent to an anhydrous gas mixture (10) containing hydrogen sulfide and at least one inert gas.

A subject of the present invention is the preparation of lithium sulfide from lithium hydroxide and hydrogen sulfide by a continuous process employing a moving bed (or circulating bed).

### STATE OF THE PRIOR ART

Lithium sulfide (Li₂S) is an essential raw material for the manufacture of the solid electrolytes employed in next-generation batteries. Solid electrolytes are less flammable than liquid electrolytes and are potentially more efficient and lighter.

There are several known methods for synthesizing lithium sulfide, which all encounter the extremely hydrophilic nature of this compound. Specifically, at ambient temperature lithium sulfide is highly reactive with moisture and spontaneously reacts on contact with water to form lithium hydroxide (LiOH) while releasing hydrogen sulfide (H₂S). Thus, the reaction conditions must be controlled perfectly in order to avoid any degradation of the lithium sulfide as it is formed. Once the lithium sulfide has been formed, strict control of its residual water content is indispensable, in particular via storage in a dry and inert atmosphere.

It is moreover desirable to be able to produce lithium sulfide having the highest possible degree of purity and being in the form of solid particles having an average particle size of less than 1 mm. These properties lead to good stability and good capacitance of the electrolyte.

One known method for synthesizing lithium sulfide consists in reacting lithium hydroxide with hydrogen sulfide, according to the following reaction:

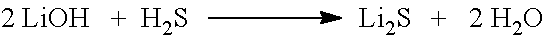

This route is often used since the starting raw material LiOH is available and inexpensive and because the reaction, which is endothermic, can be carried out at a moderate temperature generally of between 13° and 450° C.

However, the industrial processes that employ this synthesis route encounter several drawbacks, starting with the significant amount of water produced by the reaction, which must be completely removed in order to avoid the reconversion of the Li₂S to LiOH.

Moreover, the starting raw material LiOH is generally present in the hydrated form LiOH·H₂O, and a step of thorough drying thereof is necessary in order to be able to begin the sulfidation proper.

This is because the degree of sulfidation of the hydrated form LiOH·H₂O is too low.

Moreover, the presence of this hydrated form in the sulfidation reactor results in the formation of blocks of lithium sulfide, i.e. larger lithium sulfide particles consisting of aggregates of Li₂S surrounding an inner core of unsulfided LiOH·H₂O. Thus, the quality of the lithium sulfide obtained is greatly reduced: not only is its purity lower, but its average particle size also increases.

Various processes have been described in the prior art, including in particular discontinuous processes (or “batch” mode processes), employing reactors in which the solid particles can in particular be agitated or put into a fluidized bed. Such batch processes are described, for example, in the patent applications EP 0 802 159, JP2020033259A, JP2015137183 and WO2018/141919.

These processes often require a very large amount of sulfiding agent (H₂S). These processes additionally encounter problems of maintaining the temperature of the reactor (since the reaction is endothermic) and of removing the water formed over the course of the reaction. Lastly, the processes operating in batch mode are less productive on the industrial scale since they require regular interruptions to production and significant logistics with the loading and unloading of the reactors.

These processes are therefore less economical and often result in lithium sulfide of lower quality and purity, which contains residual LiOH and particles of larger particle size on account of the presence of aggregates of Li₂S and of LiOH·H₂O.

Few continuous processes exist on account of the significant constraints associated with the LiOH sulfidation reaction.

The present invention aims to propose a process that makes it possible to prepare lithium sulfide continuously on an industrial scale.

The invention also has the aim of making it possible to prepare lithium sulfide with a high degree of chemical purity, in the form of particles with a small particle size.

### SUMMARY OF THE INVENTION

The applicant has now developed an innovative process that makes it possible to produce lithium sulfide of excellent quality from lithium hydroxide and hydrogen sulfide by a continuous process employing a moving bed (or circulating bed) circulating in at least one reactor having a particular configuration.

The process according to the invention is characterized in that the key step of sulfidation of the lithium hydroxide is carried out in a reaction zone comprising at least one tubular reactor the configuration of which is that of an ascending vibrating spiral, in which the lithium hydroxide circulates in countercurrent to a stream of anhydrous sulfiding gas containing hydrogen sulfide and an inert gas.

Thus, a subject of the present invention is a process for preparing lithium sulfide (Li₂S) from lithium hydroxide (LiOH) and hydrogen sulfide (H₂S), characterized in that the sulfidation of the lithium hydroxide is carried out in a reaction zone comprising at least one moving bed tubular reactor having the configuration of an ascending vibrating spiral, in which the lithium hydroxide circulates in countercurrent to an anhydrous gas mixture containing hydrogen sulfide and at least one inert gas.

The process according to the invention makes it possible to prepare lithium sulfide with high yields, and in particular with a mass yield of greater than 80%.

Moreover, it makes it possible to sulfide the lithium hydroxide under controlled temperature conditions. In particular, the maintenance in the reactor of a temperature within the desired operating range of 150 to 450° C. is facilitated, the endothermic nature of the reaction being compensated for by the circulation of the bed of lithium hydroxide particles.

Moreover, in contrast to the prior art processes, the lithium sulfide formed over the progression thereof through the reactor does not remain in contact with water, which is removed with the gaseous stream circulating in the opposite direction.

Thus, the process according to the invention makes it possible to obtain lithium sulfide of high purity, of greater than 99.0% by mass.

Moreover, the lithium sulfide exiting the reactor does not encounter anything other than the incoming stream of anhydrous sulfiding gas based on hydrogen sulfide and inert gas, which guarantees obtaining a product having a residual lithium hydroxide content which is particularly low, of less than 1% by mass.

According to the present invention, the reaction zone comprises at least one tubular reactor the configuration of which is that of an ascending vibrating spiral. In such a reactor, the LiOH particles progress upwards along a vibrating helical coil, in countercurrent to the descending stream of anhydrous sulfiding gas.

This configuration has the additional advantage of making it possible to avoid the formation of blocks of lithium sulfide in the form of aggregates of Li₂S surrounding an inner core of LiOH·H₂O. Specifically, the LiOH particles move in upwards leaps brought about by the vibrations of the helical coil, which ensures a high degree of mixing of the particles within the stream of sulfiding gas and leads to a better contact of the LiOH particles with the sulfiding gas, while avoiding the formation of masses via impacts of the particles against the walls of the reactor.

Compared to the processes described in the prior art, this configuration also makes it possible to reduce the flow rate of sulfiding gas and the amount of hydrogen sulfide employed, by virtue of the improved contact of the sulfiding gas and the lithium hydroxide. It makes it possible to accelerate the reaction of sulfidation of the latter and to efficiently remove the water as it is formed.

Other subjects, features, aspects and advantages of the invention shall become even more clearly apparent on reading the description and the appended nonlimiting FIGURE:

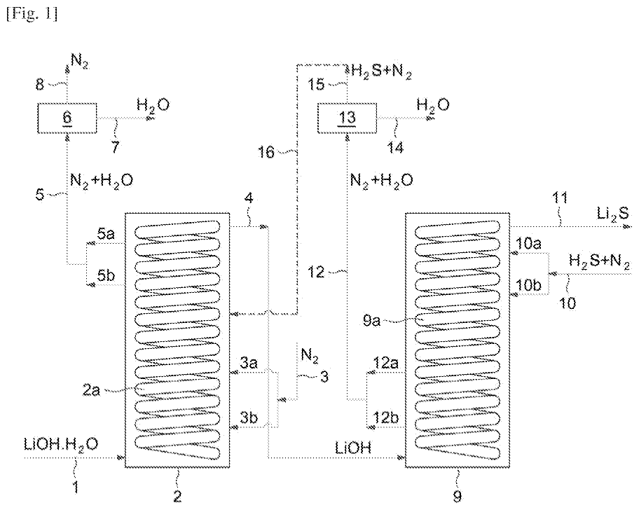

FIG. 1 illustrates an example of a unit for producing lithium sulfide in accordance with the process of the invention.

In the text that follows, and unless otherwise indicated, the limits of a range of values are included within this range, especially in the expressions “of between” and “ranging from . . . to . . . ”.

Moreover, the expressions “at least one” and “at least” used in the present description are equivalent respectively to the expressions “one or more” and “greater than or equal to”.

### DETAILED DESCRIPTION

### Sulfiding Gas

The present invention uses an anhydrous gas mixture containing hydrogen sulfide and at least one inert gas.

This gas mixture is anhydrous, that is to say its water content is less than or equal to 1% by volume.

The gas mixture contains hydrogen sulfide (H₂S), which is the sulfiding agent that reacts with the lithium hydroxide in order to form lithium sulfide while liberating water.

The content of hydrogen sulfide in the gas mixture is advantageously within the range extending from 30% to 90% by volume, preferably from 40% to 80%, more preferentially from 50% to 70%, and better still from 55% to 65% by volume, relative to the total volume of said mixture.

The gas mixture also comprises at least one inert gas, that is to say an unreactive gas. Inert gases are well known to those skilled in the art.

The inert gas(es) may in particular be chosen from nitrogen (N₂) and noble gases such as argon, helium, krypton, neon and xenon, and mixtures thereof.

Preferably, the inert gas(es) are chosen from argon, nitrogen and mixtures thereof, and more preferentially the inert gas is nitrogen.

The inert gas content is advantageously in the range extending from 10% to 70% by volume, relative to the total volume of the gas mixture.

Preferably, the gas mixture further comprises hydrogen (H₂). In this case, the content of hydrogen in the gas mixture is advantageously in the range extending from 5% to 30% by volume, preferably from 10% to 20%, relative to the total volume of the mixture.

### The Reaction Zone

In the present invention, the sulfidation of the lithium hydroxide is carried out in a reaction zone comprising at least one moving bed tubular reactor having the form of an ascending vibrating spiral in which the lithium hydroxide circulates in countercurrent to the sulfiding gas.

The term “moving bed reactor” denotes, in a manner known per se, any reactor in which solid particles circulate from the inlet to the outlet of the reactor. In the reactor in the form of an ascending vibrating spiral that is employed in the invention, the particles progress upwards along a spiral. Their progression is brought about by the vibrations of the tubular reactor.

A particular feature of the process of the invention is that the conversion of the lithium hydroxide to lithium sulfide is carried out in a tubular reactor at the inlet of which the lithium hydroxide particles are introduced and are circulated towards the outlet. Conversely, the sulfiding gas is introduced at the outlet of the reactor and circulates towards the inlet thereof.

In the present description, the terms reactor “inlet” and “outlet” are defined with respect to the ascending circulation direction of the solid lithium hydroxide particles in the tubular reactor.

Thus, inside the reactor, two streams circulate in countercurrent to one another, one solid and the other gaseous:
The solid stream consists of the lithium hydroxide particles. As it progresses upwards in the reactor, the solid stream becomes depleted in lithium hydroxide and enriched in lithium sulfide;
The gas stream consists of the sulfiding gas, that is to say the anhydrous gas mixture containing hydrogen sulfide and at least one inert gas. As it progresses downwards in the reactor, the gas stream becomes depleted in hydrogen sulfide and enriched in steam.

According to a preferred embodiment, said anhydrous gas mixture is introduced into the reaction zone at at least two points thereof: at the outlet of the reaction zone and at at least one point located between the outlet and the inlet of the reaction zone.

More preferably, said anhydrous gas mixture is introduced at the outlet of the reaction zone and at at least two different successive points positioned between the outlet and the inlet of the reaction zone.

The introduction of the anhydrous gas mixture at multiple successive points along the reaction zone provides in particular the following advantages:
It makes it possible to work locally at a stoichiometric excess of H₂S in order to guarantee a maximum rate of conversion of LiOH to Li₂S;
It makes it possible to locally lower the partial pressure of H₂O and thus to limit the inhibitory effect thereof on the conversion of LiOH to Li₂S.

In this embodiment, the composition of said anhydrous gas mixture may be different between the various points of introduction. In particular, the content of H₂S may be different, for example higher the closer the point of injection of the mixture is to the outlet of the reaction zone.

The temperature inside the reactor(s) is advantageously maintained in the range extending from 150 to 450° C., preferably from 300 to 450° C. and better still from 350 to 400° C.

The temperature inside the reactor(s) can be determined in a manner known per se, using thermocouples.

Because of the endothermic nature of the reaction, it is important to be able to control the temperature in order to ensure as constant a temperature as possible in the reactor, and in any case in order not to have reaction zones at a temperature of less than or equal to 100° C. This is facilitated by the use of the countercurrent process and by the potential presence of multiple reactors in the reaction zone, as described below.

According to the present invention, the temperature at the inlet of the reaction zone is greater than or equal to 350° C. and less than or equal to 450° C.

At the outlet of the reaction zone, the temperature is generally less than or equal to 450° C., or even less than or equal to 350° C.

The pressure inside the reactor(s) is maintained at a value of less than 3 bar (3×10⁵ Pa), preferably of less than 2 bar (2×10⁵ Pa), and more preferentially still of less than 1.3 bar (1.3×10⁵ Pa).

The applicant has observed, surprisingly, that the process of the invention made it possible to obtain conversion yields of LiOH to Li₂S using smaller amounts of H₂S and with lower flow rates than in the prior art. In the process of the invention, the hourly space velocity of the hydrogen sulfide is advantageously in the range extending from 30 to 450 h⁻¹.

A particular reactor employed in the invention consists of a vibrating spiral of substantially tubular form helically surrounding a vertical axis and comprising at least two steps.

The cross section of the spiral is preferentially circular and in this case the spiral is a tube. In general, the tube has a diameter of between 100 and 300 mm. It typically has a developed length that may range up to 400 m.

The tube is hollow, that is to say that it does not comprise elements in its inner portion.

The total height of the spiral may range from 5 to 40 m, preferably from 10 to 20 m.

The climb angle of the spiral may range from 1 degree to 10 degrees, preferably from 1 to 5 degrees, and more preferentially still from 1 to 4 degrees.

The reactor has a number of turns ranging preferably from 15 to 60, more preferentially from 25 to 40.

Typically, the number of turns is such that it enables a flow rate of the particles that may range from 50 to 6000 kg/h, preferably from 50 to 500 kg/h, and a gas hourly space velocity (GHSV) typically of 50 to 1500 h¹, preferably of 50 to 500 h⁻¹. The solid particles typically occupy from 5% to 80% of the volume of the turns, preferably from 10% to 50%.

Said vibrating spiral advantageously consists of a metallic material.

Preferably, it consists of a metal tube made from a metal alloy, more preferentially from steel.

It may be obtained, for example, by shaping a metal tube in the form of a helix about a substantially vertical axis. According to an advantageous embodiment, a central pillar makes it possible to stiffen and support the helix formed by the spiral. The spiral may be electrically insulated from the central pillar by the fastening system.

According to a preferred embodiment, a transformer supplies the vibrating spiral at at least one step (i.e. at least one turn) with low-voltage current, of less than 50 V, which makes it possible to directly heat, via Joule heating, the metal mass of the tube to the temperature required in the reactor.

In particular, one or more steps (one or more turns) are heated by Joule heating at a temperature of 150 to 450° C., especially in the lower portion of the reactor, in the inlet zone of the LiOH particles. The direct consequence of the Joule heating is the generation of heat in the mass of the turn. It makes it possible to obtain greater flexibility for controlling the temperature at the core of the turn, compared to indirect heating for example by means of a heat transfer fluid.

The vibrations of the reactor in the form of a spiral may be produced by at least one system placed at any adequate level, for example at the base or at the tip of the pillar or else positioned around the spiral. Among the suitable vibration systems, mention may be made of the following systems: unbalanced motors, electromagnetic vibrators (excited by a variable cycle with the creation of pulses) and unbalanced excitations. Preferably, the vibrations are produced by a table acting as a support for the central pillar and actuated by two unbalanced motors.

The reaction zone may consist of one or more moving bed reactors.

Preferably, the reaction zone contains at least two moving bed reactors. The reaction zone may thus consist of multiple moving bed reactors, which may be arranged in series and/or in parallel. Said moving bed reactors may be of identical configurations (in particular when they are arranged in parallel) or of different configurations. Thus, a plurality of moving bed reactors may be employed that may all, or for a portion thereof, consist of tubular reactors having the configuration of vibrating spirals. When multiple vibrating spirals are used, they may be of different sizes.

Lithium sulfide Li₂S.

At the outlet of the reaction zone, the lithium sulfide is recovered in the form of solid particles of small size such as for example beads, or particles of more or less cylindrical shape or of irregular shape.

The number-average size of the lithium sulfide particles, corresponding to the diameter of the equivalent spherical volume, is preferably less than or equal to 4 mm, and more preferably less than or equal to 1 mm.

The average size here denotes the number-average value of the diameter of the particles by assimilating them to spheres, and is defined by the d50 median diameter, measured by laser diffraction particle size analysis, for example using a device known as a laser diffraction particle size analyzer, which makes it possible to determine the size distribution of a population of particles.

In the case where the particles are effectively spherical, the average size is equal to the average diameter.

According to an advantageous embodiment, a portion of the stream of particles leaving the reaction zone is recycled into said zone, either at its inlet or at an intermediate point thereof. Recycling at an intermediate point is facilitated in particular when the reaction zone comprises multiple reactors in series, the recycled particles being introduced for example between two successive individual reactors.

Such a recycling of the stream of particles leaving the reaction zone is advantageous when the conversion of LiOH to Li₂S is not complete at the end of a single passage through the reaction zone.

### Lithium Hydroxide LiOH

The lithium hydroxide introduced at the inlet of the reaction zone is present in the form of solid particles of small size such as for example beads, or particles of more or less cylindrical shape or of irregular shape.

The number-average size of the lithium hydroxide particles, corresponding to the diameter of the equivalent spherical volume, is preferably within the range extending from 10 μm to 4 mm.

The average size here denotes the number-average value of the diameter of the particles by assimilating them to spheres, and is defined by the d50 median diameter, measured by laser diffraction particle size analysis, for example using a device known as a laser diffraction particle size analyzer, which makes it possible to determine the size distribution of a population of particles.

In the case where the particles are effectively spherical, the average size is equal to the average diameter.

According to a preferred embodiment, the lithium hydroxide is introduced into the reaction zone with a water content of less than 10 mol %.

### The Preliminary Drying Step

According to a preferred embodiment, prior to being introduced into the reaction zone, the lithium hydroxide undergoes a drying step. This step is typically carried out in a drying zone and is aimed at producing lithium hydroxide in anhydrous form according to the following process:

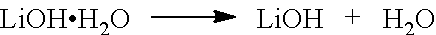

The drying step is preferably carried out by subjecting the lithium hydroxide to a heat treatment at a temperature within the range extending from 150 to 350° C., preferably from 175 to 250° C., and by circulating at least one inert gas in the drying zone so as to remove the water.

The inert gas(es) may in particular be chosen from nitrogen (N₂) and noble gases such as argon, helium, krypton, neon and xenon, and mixtures thereof.

Preferably, the inert gas(es) are chosen from argon, nitrogen and mixtures thereof, and more preferentially the inert gas is nitrogen.

The pressure inside the drying zone is advantageously maintained at a value of less than 3×10⁵ Pa (3 bar), preferably of less than 2×10⁵ Pa (2 bar), and even better still of less than or equal to 1.3×10⁵ Pa (1.3 bar).

The drying step is preferably carried out continuously, and more preferentially in a drying zone comprising one or more moving bed reactors in which the lithium hydroxide particles circulate. The stream of inert gas can then circulate, in the drying zone, in cocurrent with or in countercurrent to the stream of lithium hydroxide particles. Preferably, the stream of inert gas circulates in the drying zone in cocurrent with the stream of lithium hydroxide particles.

According to a first particularly preferred embodiment, at least one moving bed reactor of the drying zone is a tubular reactor in the form of an ascending vibrating spiral. In such a reactor, the particles progress upwards along a spiral, in which they are progressively converted to anhydrous LiOH with the elimination of water.

The tubular reactors in the form of a vibrating spiral have been described above. In this embodiment, the stream of inert gas preferably circulates upwards in said vibrating spiral (i.e. in cocurrent with the stream of solid particles). However, a descending circulation of the stream of inert gas in the vibrating spiral (i.e. in countercurrent to the stream of solid particles) may also be implemented.

According to a second embodiment, at least one moving bed reactor of the drying zone is a horizontal tubular reactor comprising a thermal screw, that is to say an endless screw, or Archimedes screw, in which the particles are conveyed and dried in a continuous flow, with elimination of water. In such a reactor, the LiOH·H₂O particles progress along the blades of a screw, in which they are progressively converted to anhydrous LiOH with the elimination of water.

The thermal screw can be heated electrically or by a heat transfer fluid and heat exchange can occur through the trough, the central core or the coils. The stream of inert gas may be injected in cocurrent with or in countercurrent to the stream of solid particles, preferably in cocurrent.

### The Presulfidation Step

Preferably, a presulfidation of the lithium hydroxide is also carried out during the drying step as described above. The term “presulfidation” denotes a partial sulfidation of the lithium hydroxide, such that the anhydrous lithium hydroxide at the end of the drying step contains from 5% to 40% by mass of lithium sulfide Li₂S.

This presulfidation is advantageously carried out by bringing the particles of lithium hydroxide, during their circulation in the drying zone, into contact with an anhydrous gas mixture containing at least one inert gas and from 5% to 30% by volume of hydrogen sulfide, relative to the total volume of said mixture.

This gas mixture is anhydrous, that is to say its water content is less than or equal to 1% by volume.

The content of hydrogen sulfide in the gas mixture used for the presulfidation is more preferentially within the range extending from 10% to 15% by volume, relative to the total volume of said mixture.

The inert gas(es) are chosen from those described above for the drying step, including nitrogen (N₂), noble gases and mixtures thereof. Preferably, the inert gas(es) are chosen from argon, nitrogen and mixtures thereof, and more preferentially the inert gas is nitrogen.

According to a preferred embodiment, the inert gas(es) present in the gas mixture used for the presulfidation of lithium hydroxide is/are that/those used for the drying. Thus, for example, the presulfidation may be carried out by directly adding, to the gas stream circulating in the drying zone, hydrogen sulfide, or a mixture comprising hydrogen sulfide, inert gas and optionally hydrogen as described below.

Preferably, the gas mixture used for the presulfidation further comprises hydrogen (H₂). In this case, the content of hydrogen in the gas mixture is advantageously in the range extending from 1% to 10% by volume, preferably from 2% to 5% by volume, relative to the total volume of said mixture.

According to a preferred embodiment, said gas mixture used for the presulfidation of the lithium hydroxide consists wholly or partially of the gas mixture recovered at the outlet of the reaction zone, dried beforehand in order to remove the water therefrom. If necessary, this gas mixture may be diluted with inert gas in order to adjust the hydrogen sulfide content thereof to the concentration required for the presulfidation.

The gas mixture used for the presulfidation may be introduced at one or more points of the drying zone, preferably located downstream of the inlet zone for the lithium hydroxide particles. Specifically, the presulfidation step is advantageously initiated at a point in the drying zone where the water content of the lithium hydroxide is sufficiently low.

Thus, the gas mixture used for the presulfidation is preferentially brought into contact with the lithium hydroxide circulating in the drying zone at one or more injection points located in the downstream portion of the latter, i.e. in the second half thereof, relative to the point of injection of the solid Preferably, the gas mixture used for the presulfidation circulates in the drying zone in cocurrent with the stream of lithium hydroxide particles.

In the case where the drying zone is in the form of an ascending vibrating spiral, typically the gas mixture used for the presulfidation is introduced at one, two or three points, preferably located in the upper half of the spiral.

It advantageously circulates upwards, in cocurrent with the ascending stream of solid particles.

The step of presulfidation of the lithium hydroxide is advantageously carried out at a temperature in the range extending from 150 to 350° C., preferably from 175 to 250° C.

This presulfidation step makes it possible to improve the degree of drying of the lithium hydroxide and increase the sulfidation rate in the downstream reaction zone.

Appended FIG. 1 illustrates a non-limiting example of a unit for producing lithium sulfide. In accordance with the present invention, the lithium hydroxide (LiOH) is converted to lithium sulfide (Li₂S) in a reaction zone 9 which comprises a moving bed tubular reactor constituted of an ascending vibrating spiral 9a.

The lithium hydroxide particles are introduced into the lower portion of the reaction zone 9 via line 4. The particles progress upwards in the spiral 9a, this progression being brought about by the vibrations of the spiral.

An anhydrous gas mixture containing hydrogen sulfide in stoichiometric excess and nitrogen is introduced into the upper portion of the reaction zone 9. This mixture is conveyed via line 10 and introduced into the spiral reactor 9a at two successive injection points 10a and 10b located in the upper portion of said reactor. It circulates downwards in the spiral reactor 9a, in countercurrent to the ascending stream of particles.

At the outlet of the reaction zone 9, the lithium sulfide particles are recovered and discharged via line 11.

In the lower portion of the reaction zone 9, a gas mixture containing nitrogen, water and a hydrogen sulfide residue is discharged at two successive points 12a and 12b and conveyed via line 12 to a treatment unit 13.

In the unit 13, the mixture obtained from line 12 is treated in order to remove the water therefrom, which is separated via line 14. It is also possible to carry out dedusting (not shown) of the gas mixture, in order to remove any entrained particulate dust therefrom. The mixture of nitrogen and residual hydrogen sulfide is then discharged via line 15.

Prior to its introduction into the reaction zone, the lithium hydroxide undergoes a drying step carried out in the drying zone 2, which comprises a moving bed tubular reactor which, in this example, is constituted of an ascending vibrating spiral 2a.

The particles of hydrated lithium hydroxide (LiOH·H₂O) are introduced into the lower portion of the drying zone 2 via line 1. The particles progress upwards in the spiral 2a, this progression being brought about by the vibrations of the spiral.

An inert gas consisting of nitrogen conveyed via line 3 is also introduced into the lower portion of the drying zone 2, and injected into the spiral 2a at the injection points 3a and 3b. The nitrogen progresses upwards in the spiral reactor 2a, in cocurrent with the stream of particles.

In the upper portion of the drying zone 2, the dried lithium hydroxide particles are discharged via line 4 and transferred to the reaction zone 9. Also in the upper portion of the drying zone 2, a mixture of water and nitrogen is discharged at the successive points 5a and 5b and conveyed via line 5 to a treatment unit 6.

In the unit 6, the mixture obtained from line 5 is treated in order to remove the water therefrom, which is separated via line 7. It is also possible to carry out dedusting (not shown) of the gas mixture, in order to remove any entrained particulate dust therefrom. The nitrogen is then discharged via line 8. According to an advantageous embodiment (not shown), the nitrogen thus recovered at the outlet of the drying zone is recycled to the unit, either at the level of the drying zone 2 or at the level of the reaction zone 9.

According to a preferred optional embodiment, the gas mixture of nitrogen and residual hydrogen sulfide obtained from the reaction zone 9 and dried, recovered via line 15, is recycled via line 16 to the drying zone 2 where it is introduced into the upper second half of spiral reactor 2a. This recycled gas mixture contains a hydrogen sulfide content that is lower than that of the gas mixture introduced into the reaction zone 9. This recycling makes it possible to carry out presulfidation of the lithium hydroxide particles upstream of the reaction zone 9 in the upper second half of the drying zone 2.

1. A process for preparing lithium sulfide (Li₂S) from lithium hydroxide (LiOH) and hydrogen sulfide (H₂S), comprising:
sulfiding lithium hydroxide in a reaction zone (9) comprising at least one moving bed tubular reactor (9a) having the configuration of an ascending vibrating spiral;
circulating the lithium hydroxide (4) in countercurrent to an anhydrous gas mixture (10) containing hydrogen sulfide and at least one inert gas.

2. The process of claim 1 wherein the content of hydrogen sulfide in the gas mixture (10) is within the range extending from 30% to 90% by volume, relative to the total volume of said mixture.

3. The process of claim 1 wherein the at least one inert gas is selected from the group consisting of nitrogen, noble gases, and mixtures thereof.

4. The process of claim 1 wherein that said gas mixture (10) additionally comprises hydrogen at a content within the range extending from 5% to 30% by volume, relative to the total volume of the mixture.

5. The process of claim 1 wherein said anhydrous gas mixture (10) is introduced into the reaction zone (9) at at least two points (10a, 10b) thereof: at the outlet of the reaction zone (10a) and at at least one point located between the outlet and the inlet of the reaction zone (10b).

6. The process of claim 1 wherein the reaction zone (9) comprises at least two moving bed reactors arranged in series, or in parallel, or in series and in parallel.

7. The process of claim 1 wherein the reaction zone (9) comprises a plurality of moving bed reactors that may all, or for a portion thereof, consist of vibrating spirals.

8. The process of claim 1 wherein prior to being introduced into the reaction zone (9), the lithium hydroxide (1) undergoes a drying step in a drying zone (2).

9. The process of claim 1 wherein that the drying zone (2) comprises one or more moving bed reactors (2a) in which the lithium hydroxide particles circulate.

10. The process of claim 1 wherein at least one moving bed reactor of the drying zone (2) is a tubular reactor in the form of an ascending vibrating spiral (2a).

11. The process of claim 9 comprising
presulfiding the lithium hydroxide during the drying step, by bringing the particles of lithium hydroxide (1), during their circulation in the drying zone (2), into contact with an anhydrous gas mixture containing at least one inert gas and from 5% to 30% by volume of hydrogen sulfide, relative to the total volume of said mixture.

12. The process as claimed in claim 11 wherein that the content of hydrogen sulfide in the gas mixture used for the presulfiding is within the range extending from 10% to 15% by volume, relative to the total volume of said mixture.

13. The process of claim 11 wherein said gas mixture used for the presulfiding of the lithium hydroxide (1) consists wholly or partially of the gas mixture (16) recovered at the outlet of the reaction zone (9), dried beforehand in order to remove the water therefrom.

14. The process of claim 11 wherein the gas mixture used for the presulfiding circulates in the drying zone (2) in cocurrent with the stream (1) of lithium hydroxide particles.
